(19) United States
(12) Patent Application Publication
(10) Pub. No.: US 2026/0326277 A1
(43) Pub. Date: Oct. 22, 2026

(54) MOTOR ARRANGEMENTS FOR A POWER TOOL

(71) Applicant: Milwaukee Electric Tool Corporation, Brookfield, WI (US)

(72) Inventors: Mitchell A. Gibson, New Berlin, WI (US); Jay Klubertanz, Brookfield, WI (US); Benjamin Farley, Brookfield, WI (US)

(21) Appl. No.: 19/105,714

(22) PCT Filed: Aug. 21, 2023
(86) PCT No.: PCT/US2023/072582

§ 371 Date: Feb. 21, 2025

Related U.S. Application Data
(60) Provisional application No. 63/399,831, filed on Aug. 22, 2022.
(60) Provisional application No. 63/500,891, filed on May 8, 2023.

(51) Int. Cl. B25F 5/00; B25B 21/00; B25F 5/02

(52) U.S. Cl. CPC B25F 5/001; B25B 21/002; B25F 5/02

(57) ABSTRACT

A power tool, such as a tension control (TC) and/or shear wrench is provided. The power tool includes a powertrain having a motor and an output assembly the motor defines a motor axis of rotation and the output assembly defines a drive axis of rotation, which is oriented parallel to and offset from, or perpendicular to the drive axis of rotation. The motor and the output assembly are operatively coupled by a linkage assembly, which is configured to transfer rotational power from the motor to the output assembly. The output assembly includes a transmission configured to rotate both an inner socket and an outer socket of the output assembly.

### CROSS-REFERENCE TO RELATED APPLICATIONS

The present application is based on and claims the benefit of U.S. Provisional Patent Application No. 63/500,891, filed on May 8, 2023, and U.S. Provisional Patent Application No. 63/399,831, filed on Aug. 22, 2022, which are incorporated herein by reference in their entirety.

### BACKGROUND

Tension control (TC) and/or shear wrenches are typically used in the manufacture of high-strength and/or high-load buildings (e.g., metal buildings, skyscrapers, etc.) to control the tension (e.g., torque, tightness) of a fastener. In one example, TC wrenches are configured to shear-off (e.g., remove) an end and/or spline portion of a tension control (TC) fastener after reaching a predetermined tension.

### SUMMARY

Embodiments of the invention provide a power tool (e.g., a tension control (TC) and/or shear wrench) that can include a motor and an output assembly. The motor can define a motor axis of rotation and the output assembly can define a drive axis of rotation. The motor axis of rotation can be parallel to and offset from the drive axis of rotation.

In another example, embodiments of the invention provide a power tool (e.g., a tension control (TC) and/or shear wrench) that can include a motor, an output assembly, and a linkage assembly positioned between the motor and the output assembly that can be configured to transfer rotational power from the motor to the output assembly. The motor can define a motor axis of rotation and the output assembly can define a drive axis of rotation. The motor axis of rotation can be perpendicular to the drive axis of rotation.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a cross-sectional view of one example of a power tool according to aspects of the present disclosure.

FIG. 2 is a partial schematic view of an example of a powertrain of the power tool of FIG. 1.

FIG. 3 is a cross-sectional view of another example of a power tool according to aspects of the present disclosure.

FIG. 4 is a partial schematic view of an example of a powertrain of the power tool of FIG. 3.

FIG. 5 is a cross-sectional view of another example of a power tool according to aspects of the present disclosure.

FIG. 6 is a perspective view of an example of a power tool including a support rib.

FIG. 7 is a partial cross-sectional view of the power tool of FIG. 6 including the support rib.

FIG. 8 is a perspective view of an example of the support rib for use with the power tool of FIG. 6.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The following detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

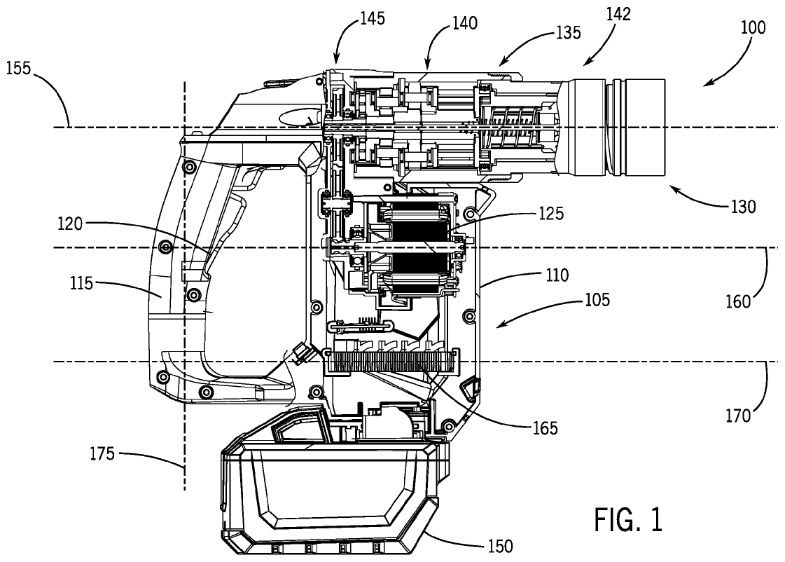

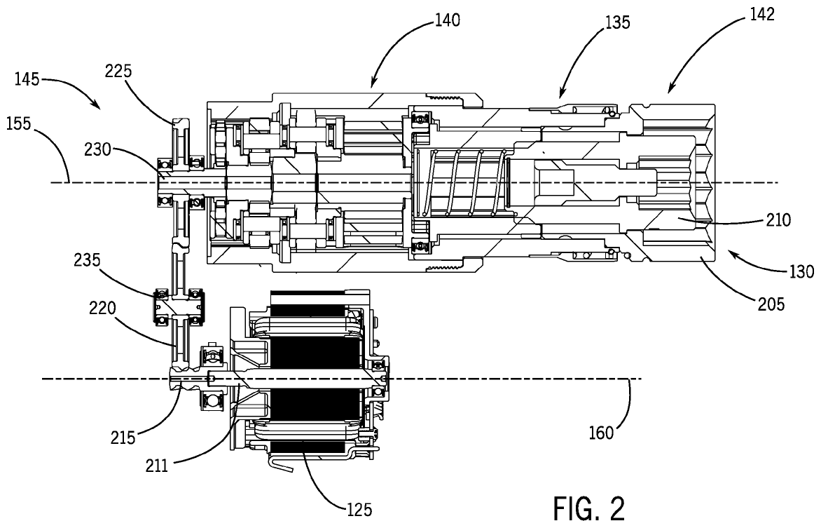

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The disclosed power tool will be described with respect to an example shear wrench. However, it should be understood that any one or more example embodiments of the disclosed power tool could be incorporated in other types of power tools (e.g., drills, drivers, etc.). Furthermore, it should be understood that one or more example embodiments of the disclosed power tool could be used outside of the context of a power tool and could more generally be used in a mechanism and/or mechanisms to secure one or more fasteners.

FIG. 1 illustrates one example of a power tool 100. In one example, the power tool 100 may be a tension control (TC) and/or shear wrench. The power tool 100 may include a housing 105 with a motor housing portion 110 and a handle 115. In one example, the housing 105 may be a clamshell type housing to enable replacement of one or more components of the housing by a user. In another example, the housing 105 may be a unitary housing (e.g., molded unitary body). The power tool 100 may be made from a variety of materials, such as polymeric material, metallic material, and/or other materials. In one example, the handle 115 may include one or more triggers 120. The triggers 120 may be used to selectively control one or more functions of the power tool 100. For example, the triggers 120 may control power, rotation, ejection of a spline portion of a fastener, and/or other functions of the power tool 100. In one particular example, the triggers 120 may be used to selectively enable power flow from a power supply 150 to a motor 125. For example, the triggers 120 may be in electrical communication with a circuit board 165 (e.g., a printed circuit board (PCB)) configured to control one or more functions of the power tool 100. In one example, the circuit board 165 may be positioned within the motor housing portion 110 of the housing 105. In one particular example, the circuit board 165 may be positioned horizontally between the motor 125 and the power supply 150. In the illustrated example, the power supply 150 is a direct current (DC) power source, specifically, a battery (e.g., a lithium ion battery). In another example, the power supply 150 may be an alternating current (AC) power source, such as a power cord connected to a wall outlet. Correspondingly, in other examples, the power supply 150 may include an inverter and/or a rectifier used to convert AC to DC power and/or DC to AC power. In one particular example, the power supply 150 may be a removable and rechargeable lithium-ion type battery.

In one example, the power tool 100 may include a powertrain 142 including the motor 125, a linkage assembly 145, and a transmission 140. In one example, the motor 125 rotates along a motor axis 160 to supply rotational power (e.g., torque) to an output assembly 135 of the power tool 100. The output assembly 135 may include an output end 130 located at a first end of the output assembly 135, with the handle 115 located adjacent a second end of the output assembly 135, below the output assembly 135. The output assembly 135 may further include the transmission 140. The transmission 140 may include one or more gearsets, such as planetary gearsets and/or other types of gearsets. For example, the transmission may include one or more planetary gearsets with one or more combinations of sun gears, planet gears, and/or ring gears configured to reduce a rotational speed of the output assembly 135 while increasing an output torque of the output assembly 135.In one example, the transmission 140 may be used to supply a torque value from the motor 125 to the output end 130 to tighten and/or loosen one or more fasteners.

In one example, the output end 130 and the transmission 140 rotate about an output axis 155, which is oriented parallel to and offset from the motor axis 160 of the motor 125. Correspondingly, both the output axis 155 of the output end 130 and transmission 140 and the motor axis 160 of the motor 125 are further oriented parallel to and offset from a board axis 170 of the circuit board 165. Further, in one example, the handle 115 defines a handle axis 175, which is oriented substantially perpendicular to each of the output axis 155, the motor axis 160, and the board axis 170.

In one example. to facilitate the orientation of the output axis 155 and the motor axis 160, the linkage assembly 145 may be configured to mechanically connect the motor 125 to the transmission 140 such that power from the motor 125 flows to the transmission 140 via the linkage assembly 145. In this configuration (e.g., horizontal motor configuration) the power tool 100 may have increased efficiency. For example, transmission 140 and linkage assembly 145 may include one or more spur gears, which increase overall efficiency of the power tool 100. As a result, the power tool 100 may have an increased service life and/or increased duration of time between charges of the power supply.

FIG. 2 shows an example of the powertrain 142. The powertrain 142 includes the motor 125, the linkage assembly 145, and the output assembly 135, which includes the transmission 140 and the output end 130. The output end 130 includes an outer socket 205 and an inner socket 210. The outer socket 205 and the inner socket 210 are configured to engage with a fastener (e.g., a tension control bolt) to be tightened by the power tool 100. In one example, the outer socket 205 is configured to engage with a first portion of the fastener (e.g., a nut for use with of a bolt) and the inner socket 210 is configured to engage with a second portion of the fastener (e.g., a tip and/or spline portion of the bolt). In one example, the transmission 140 is configured to rotate the outer socket 205 in a first direction and to rotate the inner socket 210 in a second, opposite, direction. After the fastener is tightened to a desired torque (e.g., a torque that coincides with a desired tension in the fastener), the inner socket 210 can continue to rotate, which shears off a portion of the fastener (e.g., a spline of the bolt). In one example, the sheared off portion of the fastener may be ejected from the power tool 100 automatically, or upon depression of one of the triggers 120.

In one example, the motor 125 is configured to transfer rotational power to the output end 130 via the linkage assembly 145. In example, the linkage assembly 145 may include a pinon 215, an idler gear 220, and a spur gear 225. In one example, the pinon 215 may be secured to an end of a motor shaft 211. In other examples, other means of transmitting rotational power, such as a sprocket, pulley, chain, belt, and/or other means of transmitting rotational power may be used. The pinon 215 is configured to rotate with the motor shaft during rotation of the motor 125. In one example, the pinon 215 is meshed with an idler gear 220, which is configured to transfer rotational power to a spur gear 225. In one example, the idler gear 220 may be a spur gear. In other examples, the idler gear 220 may be a helical gear, miter gear, worm gear, screw gear, bevel gear, pulley, sprocket, belt, chain, and/or any other form of gear and/or means of transmitting rotational power may be used. The idler gear 220 is rotatably supported by a bearing 235 and/or other component configured to enable bi-directional rotation of the idler gear 220. As mentioned previously, the idler gear 220 may further mesh with the spur gear 225 to transfer rotational power from the motor 125 to the transmission 140 via a drive shaft 230. In one example, the spur gear 225 is coupled to the drive shaft 230 so that rotation of the spur gear 225 (e.g., via the idler gear 220) generates corresponding rotation in the drive shaft 230 to transfer rotational power to the transmission 140. The transmission 140 may include one or more gears, such as planetary gears and/or other gears to generate the output torque desired by a user. In other examples, the transmission 140 may include multiple planetary gearsets configured to generate the desired output torque. For example, the transmission may include one or more planetary gearsets with one or more combinations of sun gears, planet gears, and/or ring gears configured to reduce a rotational speed of the output assembly 135 while increasing an output torque of the output assembly 135.

In one example, the direction of rotation (e.g., clockwise and/or counterclockwise) is the same between the pinon 215 and the spur gear 225, with the idler gear 220 rotating in the opposite direction. Put differently, the pinon 215 and the spur gear 225 each rotate in a first direction (e.g., clockwise), which corresponds to a direction of motor 125 rotation and the idler gear 220 rotates in a second direction (e.g., counterclockwise), which is opposite of the direction of motor 125 rotation. However, in other examples, the linkage assembly 145 may include another idler gear, which causes rotation of the spur gear 225 in the opposite direction from rotation of the pinon 215 and the motor 125.

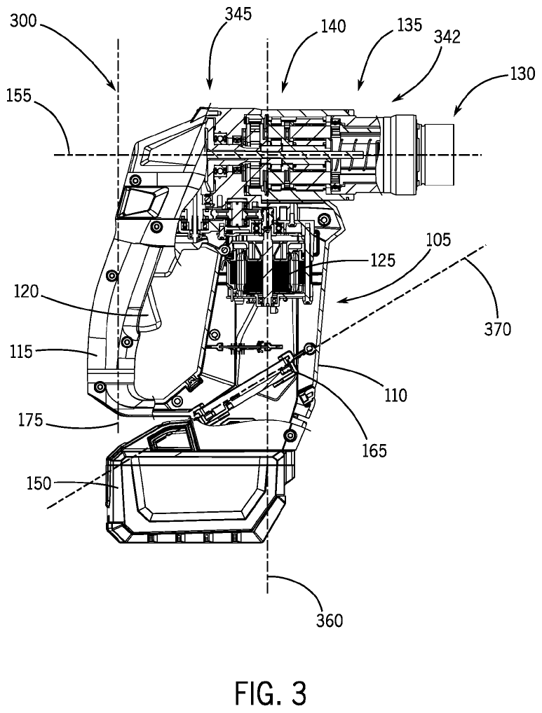

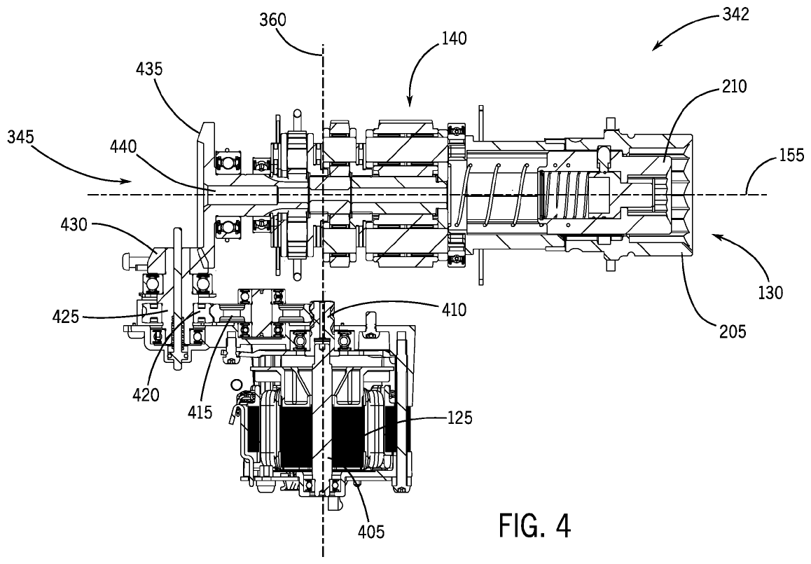

FIGS. 3 and 4 show another example of a power tool 300 including a powertrain 342. As will be recognized, the power tool 300 shares a number of components in common with and operates in a similar fashion to the examples illustrated and described previously. For the sake of brevity as well as clarity, these common features will not be again described below in detail, but please refer to the previous discussion. Only the distinctions between the power tool 300 and the examples described previously will be discussed, and unless indicated otherwise, the power tool 300 shares the same components and operates in the same fashion as the examples described previously.

The powertrain 342 includes the output assembly 135 and a linkage assembly 345. Additionally, in the powertrain 342, the motor 125 rotates along a motor axis 360, which is oriented perpendicular to the output axis 155 of the transmission 140 and the output end 130. Further, in the vertical motor arrangement, the handle axis 175 is oriented substantially parallel to the motor axis 160 and substantially perpendicular to the output axis 155. Correspondingly, a board axis 370 of the circuit board 165 is oriented (in the vertical motor arrangement) at an acute angle with respect to both the handle axis 175 and the motor axis 360, but at an obtuse angle with respect to the output axis 155.

In this orientation (e.g., vertical motor arrangement) the power tool 300 may have an overall smaller footprint (e.g., shorter length), which allows for a lighter and/or more maneuverable tool. Additionally, the position of the motor 125 within the housing 105 with respect to the handle 115 enables a user to grip the power tool 300 nearer to a center of gravity of the tool. Thus, the comfort of a user and/or overall usability and ergonomics of the power tool 300 may be improved.

To facilitate this orientation, the linkage assembly 345 may include a pinion 410, an idler gear 415, a spur gear 420, a jackshaft 425, a bevel gear 430, and a bevel gear 435. In one example, the motor 125 includes the pinion 410 secured to the motor shaft 405, which transfers rotational power from the motor 125 to an idler gear 415. In other examples, other means of transmitting rotational power, such as a sprocket, pulley, chain, belt, and/or other means of transmitting rotational power may be used. The idler gear 415 transfers rotational power to a spur gear 420, which is coupled to a first end of a jackshaft 425. In one example, rotation of the spur gear 420 generates corresponding rotation in the jackshaft 425. A bevel gear 430 is mounted to a second end of the jackshaft 425 and meshes with a corresponding bevel gear 435. In one example, the bevel gear 435 is coupled to a drive shaft 440 and is configured to transfer rotational power to the transmission 140.

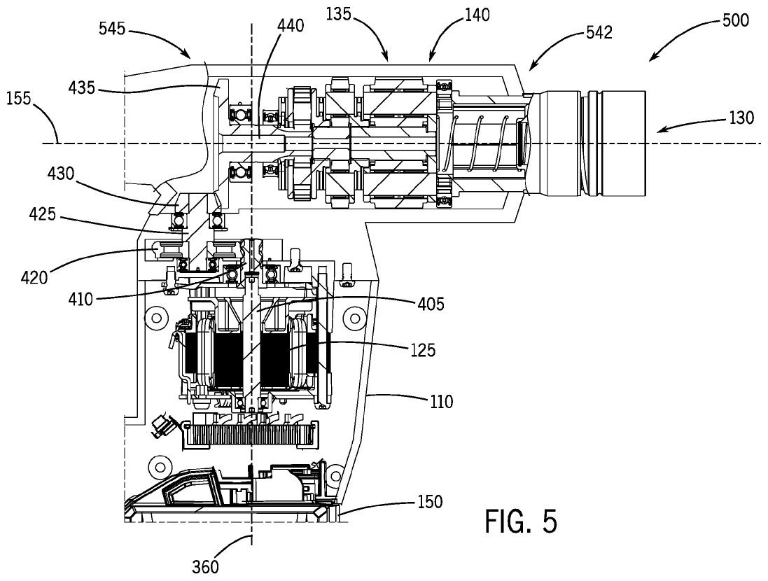

FIG. 5 shows another example of a power tool 500 including a powertrain 542. As will be recognized, the power tool 500 shares a number of components in common with and operates in a similar fashion to the examples illustrated and described previously. For the sake of brevity as well as clarity, these common features will not be again described below in detail, but please refer to the previous discussion. Only the distinctions between the power tool 500 and the examples described previously will be discussed, and unless indicated otherwise, the power tool 500 shares the same components and operates in the same fashion as the examples described previously.

The powertrain 542 includes the output assembly 535 and a linkage assembly 545. Similar to the power tool 300, in the power tool 500, the motor 125 rotates along a motor axis 360, which is oriented perpendicular to the output axis 155 of the transmission 140 and the output end 130. To facilitate this orientation, the motor 125 includes a linkage assembly 545 similar to the linkage assembly 345 described previously with respect to FIGS. 3 and 4. However, the linkage assembly 545 does not include an idler gear 415. Instead, the pinion 410 directly meshes with the spur gear 420. Additionally, removal of the idler gear 415 results in a change in the rotation direction of the bevel gear 435.

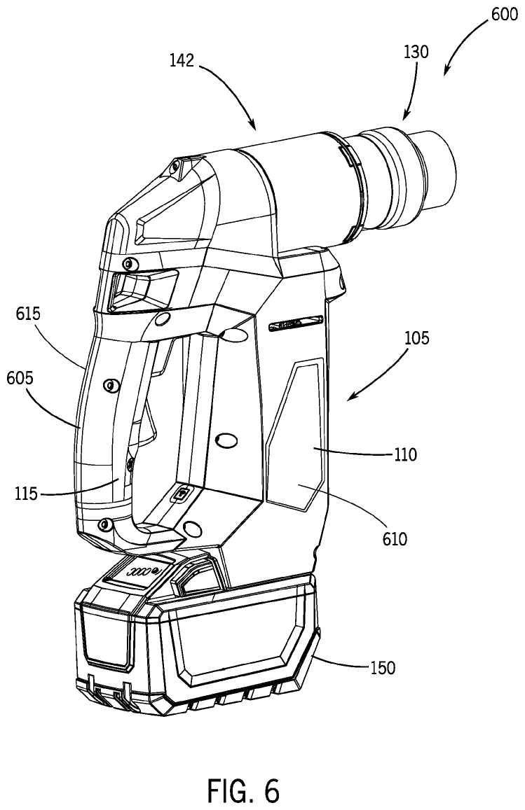

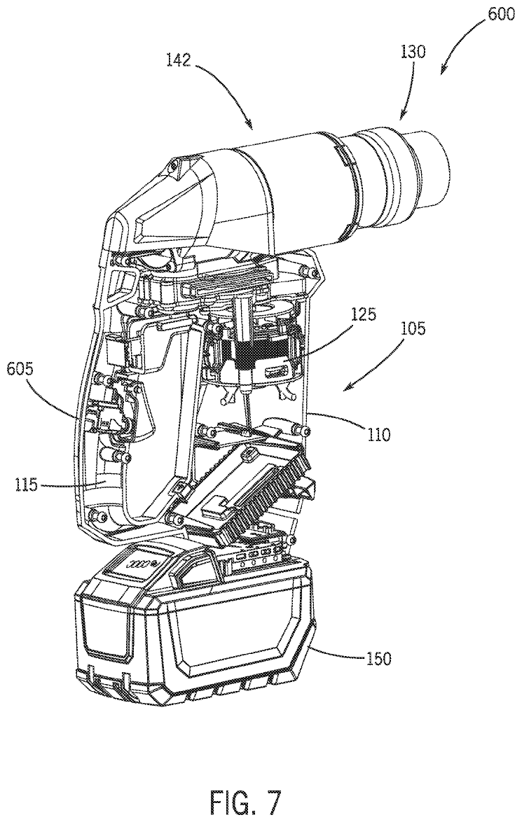

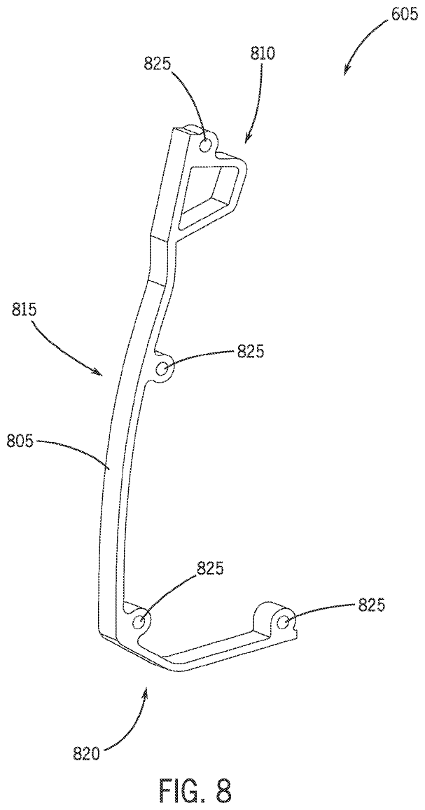

In some cases, reinforcing members can be provided to strengthen a tool body or housing, as can be useful when transferring large amounts of torque. To that end, FIGS. 6-8 show examples of a reinforcing member configured as a support rib 605 for use with a power tool 600. As will be recognized, the power tool 600 shares a number of components in common with and operates in a similar fashion to the examples illustrated and described previously. For the sake of brevity as well as clarity, these common features will not be again described below in detail, but please refer to the previous discussion. Only the distinctions between the power tool 600 and the examples described previously will be discussed, and unless indicated otherwise, the power tool 600 shares the same components and operates in the same fashion as the examples described previously.

The support rib 605 may be positioned (i.e., sandwiched) between corresponding halves of the housing 105 (i.e., in a clamshell housing arrangement) to provide additional strength and/or rigidity to the power tool 600. For example, the support rib 605 may be positioned between a first half 610 and a second half 615 of the housing 105. In another example, the support rib 605 is positioned between the first half 610 and the second half 615 of the housing 105 within the handle 115 of the housing 105. As should be appreciated, the addition of the support rib 605 may prevent cracking, breaking, and/or other failure of the housing 105 during high-torque applications.

The support rib 605 may include a body 805 defining a substantially “J” shape. The body 805 may include a first portion 810, a second portion 815, and a third portion 820. The first portion 810 may define an opening, which may be used to enable a user to add a lanyard and/or other device to secure the power tool 600. The second portion 815 and the third portion 820 may each include one or more receptacles 825, which are configured to enable a user to secure the support rib 605 between components of the housing 105. For example, a user may secure a fastener through a first half of the housing 105, through the receptacles 825 of the support rib 605, and into a second half of the housing 105 to provide rigidity and support to the housing 105. In one example, the support rib 605 may be made from metal and/or a metallic material. In other examples, the housing 105 may be made from a plastic, carbon fiber, fiberglass, and/or polymeric materials. Thus, the addition of the support rib 605 to the housing 105 provides a rigid, metallic support to the housing 105 to prevent bending and/or other failure of the housing 105 during high-torque applications.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool, comprising:
a motor defining a motor axis of rotation; and
an output assembly defining a drive axis of rotation,
wherein the motor axis of rotation is parallel to and offset from the drive axis of rotation.

2. The power tool of claim 1, further comprising:
a linkage assembly between the motor and the output assembly to transfer rotational power from the motor to the output assembly.

3. The power tool of claim 1, wherein the output assembly includes a transmission configured to rotate both an inner socket and an outer socket of the output assembly.

4. The power tool of claim 1, further comprising:
a housing, including:
a motor housing portion; and
a handle portion adjacent the motor housing portion,
wherein the motor is housed within the motor housing portion.

5. The power tool of claim 4, further comprising:
a circuit board secured within the motor housing portion of the housing;
wherein the circuit board defines a board axis; and
wherein the board axis is oriented parallel to and offset from both the motor axis and the drive axis.

6. The power tool of claim 4, wherein the handle portion defines a handle axis, and wherein the handle axis is oriented substantially perpendicular to both the motor axis and the drive axis.

7. The power tool of claim 2, wherein the linkage assembly includes:
a pinion mounted to a motor shaft of the motor;
an idler gear; and
a spur gear mounted to a drive shaft of the power tool;
wherein the idler gear is positioned between the pinion and the spur gear; and
wherein the idler gear is in mechanical communication with both the pinion and the spur gear.

8. The power tool of claim 7, wherein rotation of the motor shaft elicits corresponding rotation in the drive shaft via the mechanical communication between the pinion, idler gear, and spur gear.

9. A power tool, comprising:
a motor defining a motor axis of rotation;
an output assembly defining a drive axis of rotation; and
a linkage assembly between the motor and the output assembly, the linkage assembly configured to transfer rotational power from the motor to the output assembly,
wherein the motor axis of rotation is perpendicular to the drive axis of rotation.

10. The power tool of claim 9, wherein the output assembly includes a transmission configured to rotate both an inner socket and an outer socket of the output assembly.

11. The power tool of claim 9, wherein the linkage assembly includes:
a pinion mounted to a motor shaft of the motor;
a spur gear mounted to a first end of a jackshaft;
a bevel gear mounted to a second end of the jackshaft; and
a corresponding bevel gear mounted to a drive shaft of the power tool,
wherein the spur gear meshes with the pinion to transfer rotational power from the motor to the drive shaft of the power tool via the bevel gear.

12. The power tool of claim 11, wherein the linkage assembly further includes:
an idler gear positioned between the pinion and the spur gear,
wherein the idler gear meshes with both the pinion and the spur gear to transfer rotational power from the pinion to the spur gear.

13. The power tool of claim 9, further comprising:
a housing, including:
a motor housing portion; and
a handle portion adjacent the motor housing portion,
wherein the motor is housed within the motor housing portion.

14. The power tool of claim 13, further comprising:
a circuit board secured within the motor housing portion of the housing;
wherein the circuit board defines a board axis; and
wherein the board axis is oriented at an obtuse angle with respect to the drive axis.

15. The power tool of claim 14, wherein the handle portion defines a handle axis, and wherein the handle axis is oriented substantially perpendicular to the drive axis.

16. The power tool of claim 15, wherein the handle axis is oriented parallel to and offset from the motor axis.

17. The power tool of claim 16, wherein the board axis is oriented at an acute angle with respect to both the handle axis and the motor axis.

18. The power tool of claim 13, wherein the housing is a clamshell type housing including a first half and a second half; and wherein the housing includes a support rib positioned between the first half and the second half of the housing.

19. The power tool of claim 18, wherein the support rib is positioned within the handle portion of the housing.

20. The power tool of claim 19, wherein the support rib defines a substantially J-shaped body.
